(19) United States
(12) Patent Application Publication
(10) Pub. No.: US 2026/0104045 A1
(43) Pub. Date: Apr. 16, 2026

(54) ELECTRIC PUMP

(71) Applicant: ZHEJIANG SANHUA AUTOMOTIVE COMPONENTS CO., LTD., Hangzhou, Zhejiang (CN)

(72) Inventors: Yao GUO, Hangzhou, Zhejiang (CN); Wei YE, Hangzhou, Zhejiang (CN); Lili LIU, Hangzhou, Zhejiang (CN); Zhebin MA, Hangzhou, Zhejiang (CN)

(73) Assignee: ZHEJIANG SANHUA AUTOMOTIVE COMPONENTS CO., LTD., Hangzhou, Zhejiang (CN)

(21) Appl. No.: 19/120,775

(22) PCT Filed: Nov. 24, 2023
(86) PCT No.: PCT/CN2023/133920

§ 371 Date: Apr. 13, 2025

(30) Foreign Application Priority Data
Nov. 30, 2022 (CN) 202223196538.3

(51) Int. Cl. F04C 2/10; F04C 15/00; H02K 7/00; H02K 16/02

(52) U.S. Cl. CPC F04C 2/10; F04C 29/047; F04C 2240/808

(57) ABSTRACT

An electric pump, comprising a first rotor assembly, an electronic control assembly and a second rotor assembly. The electric pump has a first cavity and a second cavity, wherein at least part of the second rotor assembly is located in the first cavity, the first rotor assembly is located in the second cavity, and the first rotor assembly is in transmission connection with the second rotor assembly. The electronic control assembly comprises a control assembly and a pin, wherein at least part of the pin extends into the first cavity and is electrically connected to the control assembly, and the first cavity is in communication with the second cavity.

The present application claims the priority to Chinese Patent Application No. 202223196538.3, titled “ELECTRIC PUMP”, filed with the China National Intellectual Property Administration on Nov. 30, 2022, the entire disclosure of which is incorporated herein by reference.

### FIELD

The present application relates to the technical field of vehicles, and in particular to a component of a lubrication system and/or a cooling system of a vehicle.

### BACKGROUND

An electric pump typically provides power for a lubrication system and/or a cooling system of a vehicle. The electric pump includes an electric control assembly. A part of the electric control assembly generates heat during operation, and the heat may accumulate and cannot be dissipated in time. When the heat accumulates to a certain degree, the performance of the electric control assembly may be affected, and the service life of the electric pump may decrease.

### SUMMARY

An object of the present application is to provide an electric pump, which facilitates heat dissipation of an electric control assembly, thereby improving the service life of the electric pump.

To achieve the above object, a following technical solution is provided according to an embodiment of the present application.

An electric pump includes a first rotor assembly, an electric control assembly, and a second rotor assembly. The electric pump is provided with a first chamber and a second chamber. At least a part of the second rotor assembly is located in the first chamber, and the first rotor assembly is located in the second chamber. The first rotor assembly is drivingly connected to the second rotor assembly. The electric control assembly includes a control assembly and a pin, and at least a part of the pin and at least a part of the control assembly are located in the first chamber. The pin is electrically connected to the control assembly, and the first chamber is in communication with the second chamber.

According to the above technical solution, the electric control assembly includes the control assembly and the pin, and at least the part of the pin and at least the part of the control assembly are located in the first chamber. The electric pump is provided with the first chamber and the second chamber. The working medium can flow through the second chamber, and a part of the working medium in the second chamber can flow into the first chamber. When the working medium is accommodated in the first chamber, at least the part of the control assembly and at least the part of the pin are in contact with the working medium in the first chamber, so that the working medium in the first chamber exchanges heat with the control assembly and the pin, which facilitates the heat dissipation of the electric control assembly, thereby further improving the service life of the electric pump.

### BRIEF DESCRIPTION OF THE DRAWINGS

FIG. 1 is a schematic view of an electric pump according to an embodiment of the present application;

FIG. 2 is a schematic sectional view of FIG. 1;

FIG. 3 is a schematic structural view of FIG. 1 without a pump cover;

FIG. 4 is another schematic sectional view of FIG. 1;

FIG. 5 is a schematic structural view of a first housing from a perspective;

FIG. 6 is a schematic structural view of the first housing from another perspective;

FIG. 7 is a schematic view showing the connection of the first housing and a control assembly from a first perspective;

FIG. 8 is an enlarged view of a portion A in FIG. 7;

FIG. 9 is a schematic view showing the connection of the first housing and the control assembly from a second perspective;

FIG. 10 is a schematic view of a section B-B in FIG. 9;

FIG. 11 is an enlarged view of a portion C in FIG. 10;

FIG. 12 is a schematic structural view of the control assembly from a first perspective;

FIG. 13 is a schematic structural view of the control assembly from a second perspective;

FIG. 14 is a schematic perspective view of an electrical connector;

FIG. 15 is a schematic structural view of the electrical connector from a first perspective;

FIG. 16 is a schematic structural view of the electrical connector from a second perspective; and

FIG. 17 is a schematic structural view of the electrical connector from a third perspective.

### REFERENCE NUMERALS

| | | | |
|---|---|---|---|
| 1 | pump housing, | 11 | first housing, |
| 111 | first side wall, | 112 | end wall, |
| 113 | step portion, | 114 | positioning portion, |
| 115 | insertion port, | 12 | second housing, |
| 13 | pump cover, | 2 | first rotor assembly, |
| 21 | first rotor, | 22 | second rotor, |
| 23 | hydraulic chamber, | 4 | stator assembly, |
| 4a | stator core, | 4b | insulation frame, |
| 4c | winding, | 5 | control assembly, |
| 51 | circuit board, | 511 | first face, |
| 512 | second face, | 52 | electrical connector, |
| 521 | conductive portion, | 5211 | elastic sheet, |
| 5211a | first inclined portion, | 5211b | buffer portion, |
| 5211c | second inclined portion, | 522 | body portion, |
| 522a | insertion hole, | 522b | base portion, |
| 522c | connection portion, | 522d | avoidance space, |
| 53 | positioning hole, | 6 | pump shaft, |
| 7 | second rotor assembly, | 8 | output port, |
| 10 | first chamber, | 20 | second chamber, |
| 201 | bottom wall, | 30 | first passage, |
| 31 | pin, | 311 | first portion, |
| 311a | first sub-portion, | 311b | second sub-portion, |
| 311c | third sub-portion, | 312 | second portion, |
| 313 | third portion, | 40 | second passage. |

### DETAILED DESCRIPTION OF THE EMBODIMENTS

The present application is further described hereinafter in conjunction with the drawings and specific embodiments.

For those skilled in the art to better understand the technical solutions of the present application, the present application will be further described in detail in conjunction with drawings and specific embodiments hereinafter. Apparently, the drawings in the following description only illustrate some of the embodiments of the present application, and for those skilled in the art, other drawings may be obtained based on these drawings without any creative efforts. The directional terms herein, such as upper and lower, are defined based on relative positions of the components shown in the drawings, and are merely for the clarity and convenience of description of the technical solutions. It should be understood that the directional terms herein should not be construed as limitations to the protection scope of the present application.

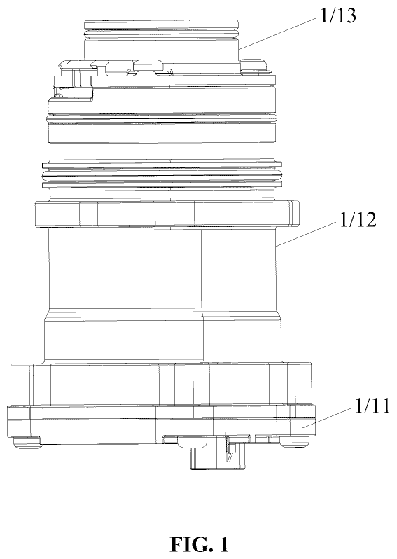

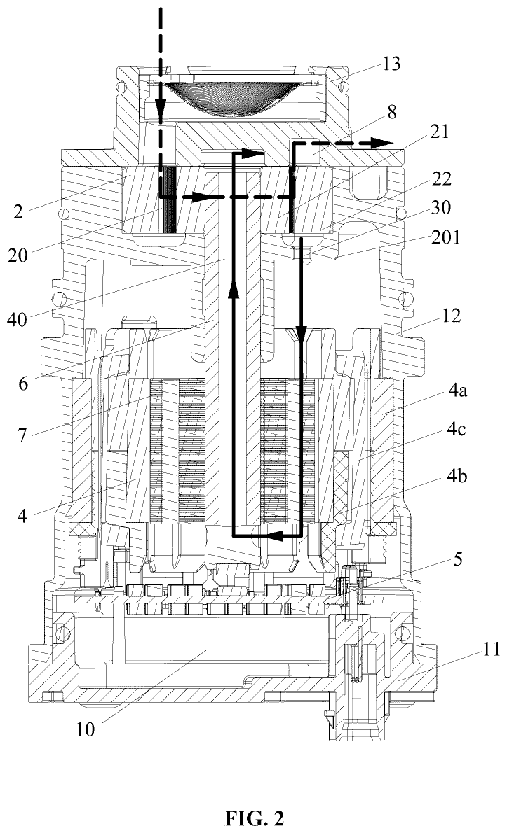

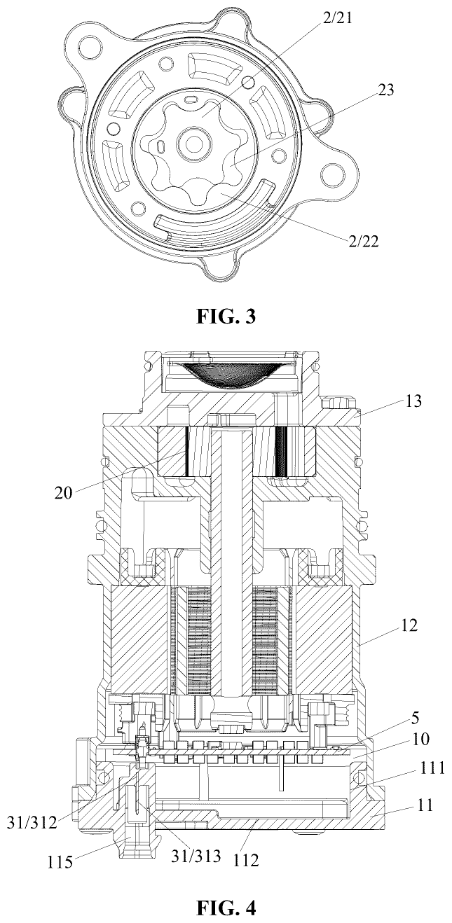

Referring to FIGS. 1 to 3, an electric pump includes a pump housing 1, a first rotor assembly 2, a second rotor assembly 7, a stator assembly 4 and an electric control assembly. The stator assembly 4 surrounds the second rotor assembly 7 on an outer radial side of the second rotor assembly 7, and the first rotor assembly 2 is drivingly connected to the second rotor assembly 7. The electric control assembly includes a control assembly 5, and the stator assembly 4 is in an electrical and/or signal connection to the control assembly 5. The stator assembly 4 includes a stator core 4a, an insulation frame 4b and a winding 4c. The insulation frame 4b at least covers at least a part of a surface of the stator core 4a, and the winding 4c is wound around the insulation frame 4b. During the operation of the electric pump, the control assembly 5 is used to control a current in the winding 4c of the stator assembly 4 to vary in a predetermined pattern, so as to control the stator assembly 4 to generate a varying excitation magnetic field. The second rotor assembly 7 rotates under the action of the excitation magnetic field, and can directly or indirectly drive the first rotor assembly 2 to rotate.

The pump housing 1 includes a first housing 11, a second housing 12 and a pump cover 13. The first housing 11 is fixedly connected to the second housing 12, and the second housing 12 is fixedly connected to the pump cover 13. The second housing 12 and the pump cover 13 are connected by a screw or a bolt, which makes it easier to assemble and disassemble the electric pump, thereby facilitating the maintenance of the first rotor assembly 2. Certainly, the second housing 12 and the pump cover 13 may be connected by other means, such as by insertion, stuck connection and the like. The first housing 11 and the second housing 12 are connected by a screw or a bolt. The first housing 11 is fixedly connected to the second housing 12. Specifically, the first housing 11 and the second housing 12 are connected by a screw or a bolt. On the one hand, this arrangement makes it easier to assemble and disassemble the electric pump. In the present embodiment, the control assembly 5 is located in a cavity between the first housing 11 and the second housing 12, and therefore this arrangement facilitates the repair of the control assembly 5 of the electric pump. On the other hand, this arrangement makes the connection between the first housing 11 and the second housing 12 more reliable. Certainly, the first housing 11 and the second housing 12 may be connected by other connection methods such as insertion, stuck connection or adhesive bonding.

A pump inner chamber is formed in the pump housing 1, and the first rotor assembly 2, the second rotor assembly 7, the stator assembly 4 and the control assembly 5 are arranged in the pump inner chamber. The pump inner chamber includes a first chamber 10 and a second chamber 20 that are in communication with each other. The first rotor assembly 2 is located in the second chamber 20. The second rotor assembly 7 (or at least a part of the second rotor assembly 7) and the stator assembly 4 (or at least a part of the stator assembly 4) are located in the first chamber 10. At least a part of the control assembly 5 is located in the first chamber 10. The control assembly 5 and the stator assembly 4 are located in the same chamber, which can reduce the axial dimension of the electric pump, leading to a compact structure, thereby reducing the production cost of the electric pump. The electric pump includes a bottom wall 201, and the first rotor assembly 2 is supported by the bottom wall 201. In an axial direction of the electric pump, the bottom wall 201 separates the first chamber 10 from the second chamber 20. In an embodiment, in the axial direction of the electric pump, the first chamber 10 is located on one side of the bottom wall 201, and the second chamber 20 is located on the other side of the bottom wall 201. The electric pump includes a first passage 30 that passes through the bottom wall 201. During the operation of the electric pump, at least a part of a working medium in the second chamber 20 flows into the first chamber 10 through the first passage 30, so that there is sufficient working medium in the first chamber 10 to cool the second rotor assembly 7, the stator assembly 4 and the control assembly 5. The working medium may be a liquid such as oil.

The first rotor assembly 2 includes a first rotor 21 and a second rotor 22. The first rotor 21 includes multiple external teeth, and the second rotor 22 includes multiple internal teeth. A hydraulic chamber 23 is formed between the external teeth of the first rotor 21 and the internal teeth of the second rotor 22. In the present embodiment, the hydraulic chamber 23 is a part of the second chamber 20. When the first rotor assembly 2 rotates, a certain eccentricity is present between the first rotor 21 and the second rotor 22. When the first rotor 21 rotates, a part of the internal teeth of the second rotor 22 is engaged with a part of the external teeth of the first rotor 21, thereby driving the second rotor 22 to rotate. During a revolution of the first rotor 21 and the second rotor 22, a volume of the hydraulic chamber 23 varies. Specifically, when the first rotor assembly 2 rotates from an initial position by a certain angle, the volume of the hydraulic chamber 23 gradually increases to create a partial vacuum, so that the working medium is pumped into the hydraulic chamber 23 through the first passage 30 of the electric pump. When the first rotor 21 and the second rotor 22 continue to rotate, the volume of the hydraulic chamber 23 filled with the working medium gradually decreases, and the working medium is squeezed, so that the working medium in the hydraulic chamber 23 is pumped out to an output port 8 of the electric pump, thereby generating a flow power.

The electric pump further includes a rotating assembly that is drivingly connected to the second rotor assembly 7 and the first rotor assembly 2. The rotating assembly includes a pump shaft 6, which can drive the first rotor 21 to rotate. In the present embodiment, one end of the pump shaft 6 is connected to a part of the first rotor assembly 2, and the other end of the pump shaft 6 is connected to the second rotor assembly 7. For example, the pump shaft 6 is drivingly connected to the first rotor assembly 2 and the second rotor assembly 7. The second rotor assembly 7 drives the first rotor 21 to rotate via the pump shaft 6, so that the first rotor assembly 2 can rotate. The pump shaft 6 includes a second passage 40, and the second passage 40 passes from a first end face to a second end face of the pump shaft 6. During the operation of the electric pump, a pressure of the working medium at an inlet of the first passage 30 is higher than a pressure of the working medium at an outlet of the second passage 40, so that a pressure difference is formed in the working medium between the inlet of the first passage 30 and the outlet of the second passage 40. The working medium flows from a high-pressure position to a low-pressure position, and based on this principle, the working medium in the second chamber 20 can flow towards the outlet of the second passage 40. Since the stator assembly 4 and the control assembly 5 are located in the first chamber 10, the working medium can carry away a part of the heat of the stator assembly 4 and the control assembly 5, thereby further improving the heat dissipation efficiency of the stator assembly 4 and the control assembly 5.

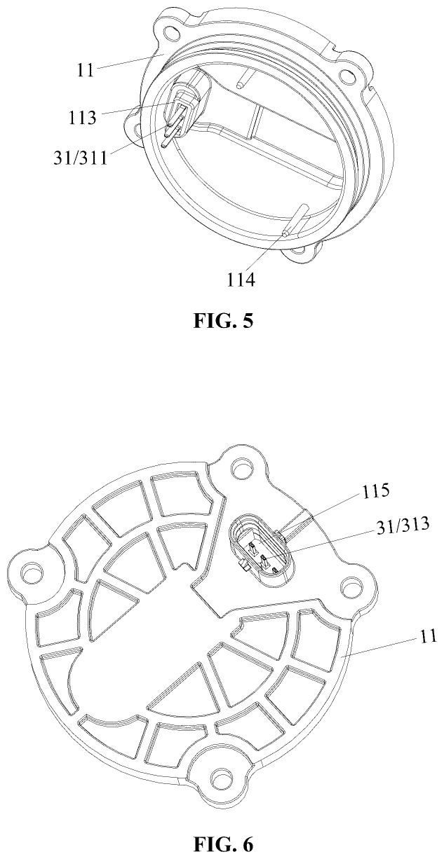

Referring to FIGS. 4 to 8, the electric control assembly includes a pin 31, and at least a part of the pin 31 extends into the first chamber 10 and is electrically connected to the control assembly 5. During the operation of the electric pump, the working medium flows through the second chamber 20. A part of the working medium in the second chamber 20 flows into the first chamber 10, and at least a part of the control assembly 5 and at least a part of the pin 31 are in contact with the working medium in the first chamber 10. In this way, the working medium in the first chamber 10 can exchange heat with the control assembly 5 and the pin 31, so as to facilitate the heat dissipation of the electric control assembly, thereby further prolonging the service life of the electric pump. Additionally, this arrangement can satisfy the needs of electric pumps of various powers, especially high-power electric pumps. No additional heat dissipation structure is needed for the heat dissipation of the control assembly 5 and the pin 31, which simplifies the structure of the electric pump while reducing the production cost of the electric pump.

The pin 31 is fixed to the first housing 11 by injection molding. The first housing 11 is provided with an insertion port 115. The insertion port 115 extends from an outer surface of the first housing 11 away from the first housing 11, and a part of the pin 31 extends into the insertion port 115.

The first housing 11 includes a first side wall 111 and an end wall 112, and the first side wall 111 is located on a side of the end wall 112. The first side wall 111 and the end wall 112 surround and define an inner chamber of the first housing 11. The inner chamber of the first housing 11 is a part of the first chamber 10. In the present embodiment, the first side wall 111 and the end wall 112 are integrally formed by injection molding, thereby improving the sealablity. Alternatively, the first side wall 111 and the end wall 112 may be formed separately, and then are fixedly connected to each other and sealed. In this way, the molds of the first side wall 111 and the end wall 112 are simple.

The pin 31 is fixed to the end wall 112 by injection molding. To improve the connection reliability between the pin 31 and the first housing 11, a step portion 113 is formed on the end wall 112. The step portion 113 protrudes from an inner surface of the end wall 112 towards the control assembly 5, and the pin 31 passes through the step portion 113. To ensure the consistency of injection molding, a spacing is present between the step portion 113 and the first side wall 111.

The pin 31 includes a first portion 311, a second portion 312 and a third portion 313. The second portion 312 of the pin 31 is integrally formed and fixed on the first housing 11 by injection molding. The first portion 311 of the pin 31 extends into the first chamber 10 and is electrically connected to the control assembly 5. In the present embodiment, the first housing 11 is provided with the insertion port 115, which extends from the outer surface of the first housing 11 away from the first housing 11, and the third portion 313 of the pin 31 extends into the insertion port 115.

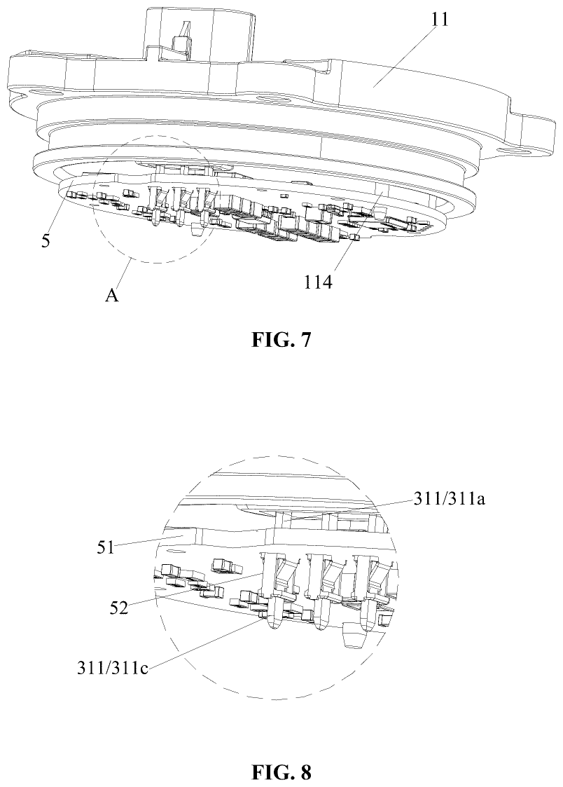

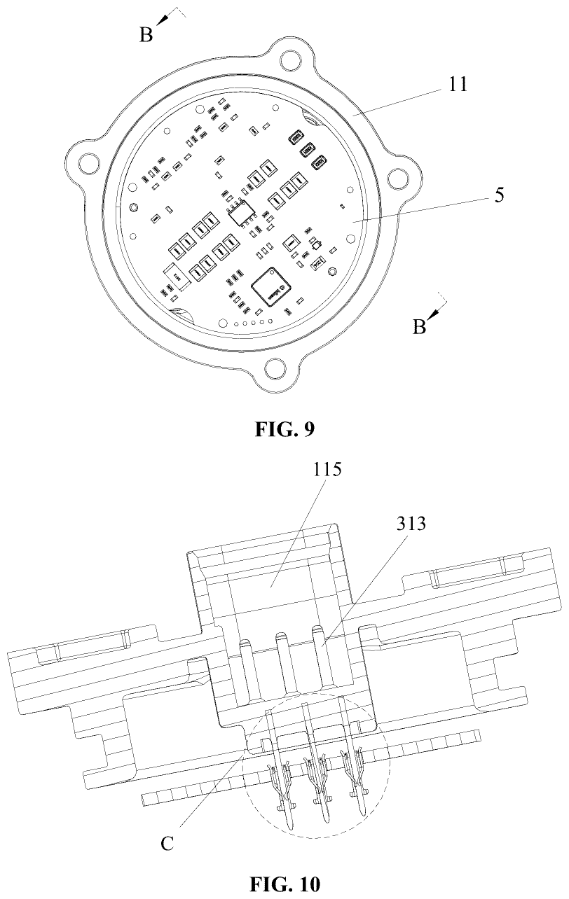

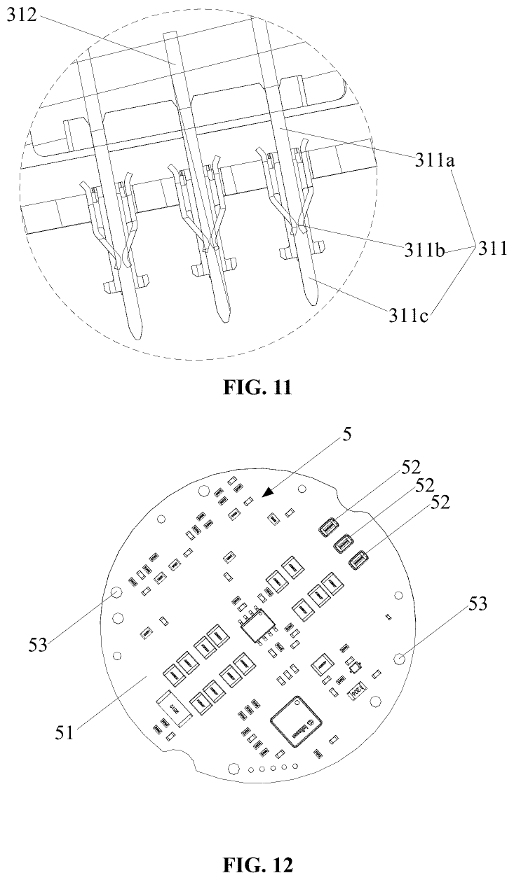

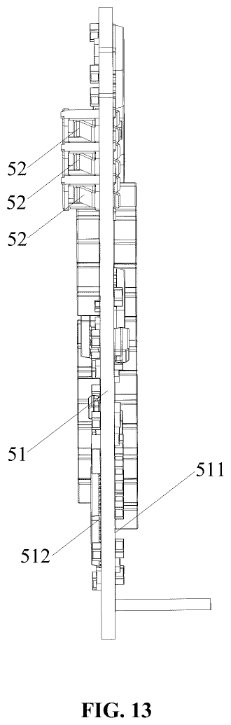

Referring to FIGS. 7 to 13, the control assembly 5 includes a circuit board 51 that is electrically connected with the pin 31. Specifically, the control assembly 5 includes an electrical connector 52 that is electrically connected to the circuit board 51, and the pin 31 is connected to the electrical connector 52. The electrical connection between the pin 31 and the circuit board 51 is achieved via the electrical connector 52 instead of by welding fixation, so that the operation manner is relatively simple. Further, an electrical connection between the first portion 311 of the pin 31 and the circuit board 51 is achieved via the electrical connector 52. The electrical connector 52 and the pin 31 have the same quantity and are in one-to-one correspondence with each another. Each pin 31 cooperates with a corresponding one of the electrical connector 52 by insertion, thereby improving the connection reliability between the pin 31 and the circuit board 51. The first housing 11 further includes a positioning portion 114, which is inserted into a positioning hole 53 of the circuit board 51. The positioning portion 114 and the positioning hole 53 have the same quantity and are in one-to-one correspondence with each other. Each positioning portion 114 cooperates with a corresponding one of the positioning hole 53, which facilitates the reliable connection between the pin 31 and the circuit board 51.

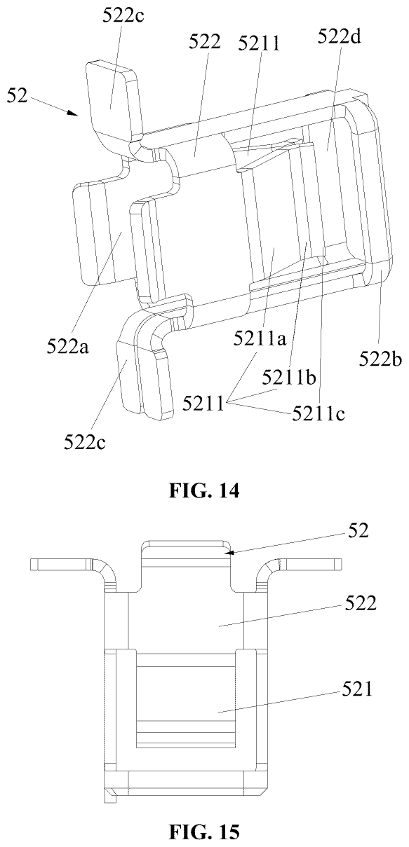

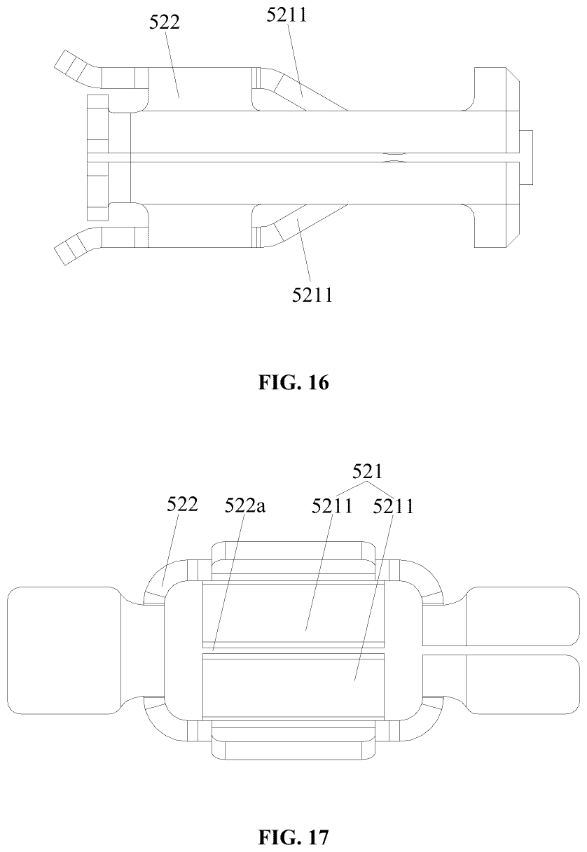

Referring to FIGS. 1 to 17 in conjunction, the electrical connector 52 includes a conductive portion 521 and a body portion 522. At least a part of the pin 31 is in contact with the conductive portion 521, and at least a part of the conductive portion 521 extends out of the circuit board 51 and is located in the first chamber 10. The conductive portion 521 can be in contact with the working medium in the first chamber 10, and may have a relatively large heat dissipation area. The body portion 522 passes through the circuit board 51 and is located in the first chamber 10. The body portion 522 can be in contact with the working medium in the first chamber 10, and may have a relatively large heat dissipation area. The first portion 311 of the pin 31 extends into the first chamber 10 and is electrically connected to the control assembly 5. The first portion 311 includes a first sub-portion 311a and a second sub-portion 311b that are connected to each other. The first sub-portion 311a passes through the circuit board 51, so as to increase a heat dissipation area of the pin 31. A part of the first sub-portion 311a is located in an insertion hole 522a, and at least a part of the second sub-portion 311b is in contact with the conductive portion 521, which facilitates the electrical connection between the pin 31 and the conductive portion 521. In some embodiments, the pin 31 further includes a third sub-portion 311c, which extends from the second sub-portion 311b away from the circuit board 51. The third sub-portion 311c is located in the first chamber 10 and is in contact with the working medium in the first chamber 10. On the one hand, this arrangement is beneficial to the increase of the heat dissipation area of the pin 31, and thus can satisfy the needs of electric pumps of various powers, especially high-power electric pumps. No additional heat dissipation structure is needed for the heat dissipation of the pin 31, which simplifies the structure of the electric pump while reducing the production cost of the electric pump. On the other hand, when the pin 31 is mounted, the tolerance in the axial direction can be accommodated, thereby ensuring the reliability of the electrical connection between the pin 31 and the electrical connector 52. The conductive portion 521 includes at least one elastic sheet 5211 that is located in the first chamber 10, which increases the contact area between the conductive portion 521 and the pin 31, thereby improving the reliability of the electrical connection between the pin 31 and the electrical connector 52. A part of the elastic sheet 5211 extends towards a central axis of the insertion hole 522a (or towards a central axis of the electrical connector 52) in an inclined manner, and another part of the elastic sheet 5211 extends away from the central axis of the insertion hole 522a (or towards a central axis of the electrical connector 52) in an inclined manner. At least a part of the second sub-portion 311b is in contact with the elastic sheet 5211 to achieve the electrical connection between the pin 31 and the electrical connector 52. Specifically, the elastic sheet 5211 includes a first inclined portion 5211a, a buffer portion 5211b and a second inclined portion 5211c. The buffer portion 5211b is connected to the first inclined portion 5211a and the second inclined portion 5211c. At least a part of the second sub-portion 311b is in contact with the buffer portion 5211b. One end of the first inclined portion 5211a is connected to the body portion 522, and the other end of the first inclined portion 5211a is connected to the buffer portion 5211b. The first inclined portion 5211a extends towards the central axis of the insertion hole 522a in an inclined manner, and the second inclined portion 5211c extends away from the central axis of the insertion hole 522a in an inclined manner. When the pin 31 passes through the insertion hole 522a to be in contact with the elastic sheet 5211, the elastic sheet 5211 is pressed away from the central axis of the insertion hole 522a. The elastic sheet 5211 can be elastically deformed, so that the pin 5211 experiences a lower resistance when being inserted into the insertion hole 522a, which reduces an operating force for inserting the pin 31 into the circuit board 51. Under the action of a restoring elastic force of the elastic sheet 5211, the elastic sheet 5211 keeps in good contact with the pin 31. In this way, the pin 31 can be inserted into and pulled out of the electrical connector 52 in an elastic manner, thereby improving the connection reliability between the pin 31 and the electrical connector 52.

In the present embodiment, two elastic sheets 5211 are provided, and the two elastic sheets 5211 are arranged opposite to each other, leading to a simple structure which is easy to be processed and formed, so as to reduce the production cost. In some embodiments, the number of the elastic sheets 5211 may be greater than two, and the multiple elastic sheets 5211 are circumferentially arranged along the insertion hole 522a. When the pin 31 is inserted into the insertion hole 522a, the pin 31 can be in contact with the multiple elastic sheets 5211, which further increases the contact area between the pin 31 and the conductive portion 521, thereby improving the connection reliability between the pin 31 and the electrical connector 52. Additionally, with action forces applied by the multiple elastic sheets 5211, the pin 31 suffers forces evenly in a circumferential direction, so as to prevent the pin 31 from being inclined, displaced or the like, thereby improving the connection reliability between the pin 31 and the electrical connector 52. Before the pin 31 is inserted into the insertion hole 522a, multiple spacings among the buffer portions 5211b of the multiple elastic sheets 5211 are relatively small. During the insertion of the pin 31, the spacings among the buffer portions 5211b of the multiple elastic sheets 5211 are gradually enlarged, and the pin 31 is clamped, which facilitates the reliable fixation of the pin 31.

The body portion 522 is fixedly connected to the circuit board 51, so that the electrical connector 52 is mechanically and electrically connected to the circuit board 51. The body portion 522 includes a base portion 522b and at least one connection portion 522c. The base portion 522b is connected to the connection portion 522c, and the connection portion 522c is fixedly connected to the circuit board 51, so that the body portion 522 is fixedly and electrically connected to the circuit board 51. At least a part of the base portion 522b extends out of the circuit board 51, and the base portion 522b can have a large contact area with the working medium in the first chamber 10, which improves the heat dissipation performance. For example, the connection portion 522c is fixed to the circuit board 51 by welding. The base portion 522b is connected to the elastic sheet 5211, and the connection portion 522c is connected to the elastic sheet 5211, so that the body portion 522 is electrically connected to the elastic sheet 5211. The base portion 522b includes the insertion hole 522a. At least a part of the insertion hole 522a is located in the circuit board 51, and the insertion hole 522a is in communication with the first chamber 10. A part of the first sub-portion 311a is located in the insertion hole 522a, and the first sub-portion 311a is spaced apart from the base portion 522b. The first sub-portion 311a can have a larger contact area with the working medium in the first chamber 10, so as to improve the heat dissipation performance. The base portion 522b is connected to an end of the elastic sheet 5211, and is provided with an avoidance space 522d for the elastic deformation of the elastic sheet 5211, so that the elastic sheet 5211 is easy to be elastically deformed, which reduces the force for inserting the pin 31 to make assembly easier. A part of the third sub-portion 311c may be located outside the base portion 522b, and the third sub-portion 311c can have a larger contact area with the working medium in the first chamber 10, which is beneficial to improving the heat dissipation performance. In the present embodiment, the electrical connector 52 includes two connection portions 522c that are fixed to the circuit board 51 by welding. The circuit board 51 includes a first face 511 and a second face 512 that are opposite to each other. The first face 511 is closer to the end wall 112 of the first housing 11 than the second face 512, and the connection portion 522c is fixed to the first face 511 of the circuit board 51 by welding. One end of the base portion 522b is connected to the connection portion 522c, and the other end of the base portion 522b passes through the circuit board 51 and extends away from the second face 512. The base portion 522b passes through the circuit board 51. The circuit board 51 has a certain thickness, and therefore serves as a reinforcement structure on a periphery of the base portion 522b, thereby supporting and fixing the base portion 522b.

It should be noted that, the above embodiments are only used to describe the present application, and are not intended to limit the technical solutions described in the present application. Although the present application is described in this specification with reference to the above embodiments, it may be understood by those skilled in the art that, modifications or equivalent substitutions may be made to the present application by those skilled in the art, and all the technical solutions and improvements thereof without departing from the spirit and scope of the present application are deemed to fall into the scope of the present application defined by the claims.

What is claimed is:

1. An electric pump, comprising:
a first rotor assembly;
an electric control assembly; and
a second rotor assembly, wherein
the electric pump is provided with a first chamber and a second chamber, at least a part of the second rotor assembly is located in the first chamber, the first rotor assembly is located in the second chamber, and the first rotor assembly is drivingly connected to the second rotor assembly; and
the electric control assembly comprises a control assembly and a pin, at least a part of the pin and at least a part of the control assembly are located in the first chamber, the pin is electrically connected to the control assembly, and the first chamber is in communication with the second chamber.

2. The electric pump according to claim 1, wherein
the control assembly comprises a circuit board and an electrical connector that are fixedly and electrically connected to each other; and
the electrical connector comprises a conductive portion, at least a part of the pin is in contact with the conductive portion, and at least a part of the conductive portion extends out of the circuit board and is located in the first chamber.

3. The electric pump according to claim 2, wherein
the pin comprises a first portion that is located in the first chamber and is electrically connected to the control assembly; and
the first portion comprises a first sub-portion and a second sub-portion that are connected to each other, the first sub-portion passes through the circuit board, and at least a part of the second sub-portion is in contact with the conductive portion.

4. The electric pump according to claim 3, wherein the first portion of the pin comprises a third sub-portion that is located in the first chamber, and the third sub-portion extends from the second sub-portion away from the circuit board.

5. The electric pump according to claim 3, wherein
the electrical connector comprises a body portion, and the body portion passes through the circuit board and is located in the first chamber;
the conductive portion comprises at least one elastic sheet that is located in the first chamber, and an end of the elastic sheet is connected to the body portion;
a part of the elastic sheet extends towards a central axis of the electrical connector in an inclined manner, and another part of the elastic sheet extends away from the central axis of the electrical connector in an inclined manner; and
at least a part of the second sub-portion is in contact with the elastic sheet.

6. The electric pump according to claim 5, wherein
the body portion comprises a base portion and at least one connection portion that are connected to each other, and the connection portion is fixedly connected to the circuit board; and
at least a part of the base portion extends out of the circuit board, and the base portion is connected to other end of the elastic sheet.

7. The electric pump according to claim 6, wherein the circuit board comprises a first face and a second face that are opposite to each other, the connection portion is located on the first face of the circuit board, one end of the base portion is connected to the connection portion, and the other end of the base portion passes through the circuit board and extends away from the second face.

8. The electric pump according to claim 6, wherein
the base portion comprises an insertion hole, and at least a part of the insertion hole is located in the circuit board; and
the insertion hole is in communication with the first chamber, a part of the first sub-portion is located in the insertion hole, and the first sub-portion is spaced apart from the base portion.

9. The electric pump according to claim 1, further comprising a bottom wall, wherein
the first rotor assembly is supported by the bottom wall; and
the electric pump comprises a first passage that passes through the bottom wall, and the first passage is in communication with the first chamber and the second chamber.

10. The electric pump according to claim 5, further comprising a bottom wall, wherein
the first rotor assembly is supported by the bottom wall; and
the electric pump comprises a first passage that passes through the bottom wall, and the first passage is in communication with the first chamber and the second chamber.

11. The electric pump according to claim 6, further comprising a bottom wall, wherein
the first rotor assembly is supported by the bottom wall; and
the electric pump comprises a first passage that passes through the bottom wall, and the first passage is in communication with the first chamber and the second chamber.

12. The electric pump according to claim 8, further comprising a bottom wall, wherein
the first rotor assembly is supported by the bottom wall; and
the electric pump comprises a first passage that passes through the bottom wall, and the first passage is in communication with the first chamber and the second chamber.

13. The electric pump according to claim 9, further comprising a pump shaft, wherein
the pump shaft is drivingly connected to the first rotor assembly and the second rotor assembly, and the pump shaft comprises a second passage that passes from a first end face to a second end face of the pump shaft; and
during operation of the electric pump, a pressure of a working medium at an inlet of the first passage is higher than a pressure of the working medium at an outlet of the second passage.

14. The electric pump according to claim 10, further comprising a pump shaft, wherein
the pump shaft is drivingly connected to the first rotor assembly and the second rotor assembly, and the pump shaft comprises a second passage that passes from a first end face to a second end face of the pump shaft; and
during operation of the electric pump, a pressure of a working medium at an inlet of the first passage is higher than a pressure of the working medium at an outlet of the second passage.

15. The electric pump according to claim 11, further comprising a pump shaft, wherein
the pump shaft is drivingly connected to the first rotor assembly and the second rotor assembly, and the pump shaft comprises a second passage that passes from a first end face to a second end face of the pump shaft; and
during operation of the electric pump, a pressure of a working medium at an inlet of the first passage is higher than a pressure of the working medium at an outlet of the second passage.

16. The electric pump according to claim 4, wherein
the electrical connector comprises a body portion, and the body portion passes through the circuit board and is located in the first chamber;
the conductive portion comprises at least one elastic sheet that is located in the first chamber, and an end of the elastic sheet is connected to the body portion;
a part of the elastic sheet extends towards a central axis of the electrical connector in an inclined manner, and another part of the elastic sheet extends away from the central axis of the electrical connector in an inclined manner; and
at least a part of the second sub-portion is in contact with the elastic sheet.

17. The electric pump according to claim 7, wherein
the base portion comprises an insertion hole, and at least a part of the insertion hole is located in the circuit board; and
the insertion hole is in communication with the first chamber, a part of the first sub-portion is located in the insertion hole, and the first sub-portion is spaced apart from the base portion.

18. The electric pump according to claim 2, further comprising a bottom wall, wherein
the first rotor assembly is supported by the bottom wall; and
the electric pump comprises a first passage that passes through the bottom wall, and the first passage is in communication with the first chamber and the second chamber.

19. The electric pump according to claim 7, further comprising a bottom wall, wherein
the first rotor assembly is supported by the bottom wall; and
the electric pump comprises a first passage that passes through the bottom wall, and the first passage is in communication with the first chamber and the second chamber.

20. The electric pump according to claim 12, further comprising a pump shaft, wherein
the pump shaft is drivingly connected to the first rotor assembly and the second rotor assembly, and the pump shaft comprises a second passage that passes from a first end face to a second end face of the pump shaft; and
during operation of the electric pump, a pressure of a working medium at an inlet of the first passage is higher than a pressure of the working medium at an outlet of the second passage.
